(19) United States
(12) Patent Application Publication
(10) Pub. No.: US 2004/0134293 A1
(43) Pub. Date: Jul. 15, 2004

(54) Igniter for an engine of a radio control model

(76) Inventor: Aling Lai, Taichung (TW)

Correspondence Address: ALING LAI, P.O. BOX 2103, Taichung, TW

(21) Appl. No.: 10/338,199

(22) Filed: Jan. 9, 2003

(51) Int. Cl. F02N 3/02

(52) U.S. Cl. 74/6; 123/185.3; 123/179.24

(57) ABSTRACT

An engine of a radio control model usually has two types of igniting. An igniter uses two unidirectional bearings to combine the two types of igniting. The two unidirectional bearings each has a rotating direction different from each other.

### BACKGROUND OF THE INVENTION

1. Field of the Invention

The present invention relates to an igniter, and more particularly to an igniter for an engine of a radio control model.

2. Description of Related Art

A first conventional igniter for an engine of a radio control model in accordance with the prior art shown in FIG. 4 comprises casing (not numbered) and an igniting device (not numbered) received in the casing.

The casing includes a front cover (51) and a rear cover (52) securely abutting each other. The rear cover (52) is cylindrical and has a container (521) defined in the rear cover (52). A through hole (511) is defined in the front cover (51) and centrally communicates with the container (521) in the rear cover (52).

The igniting device includes a coupling (61) rotatably received in the through hole (511) in the front cover (51) and a unidirectional bearing (611) rotatably mounted in the coupling (61). The coupling (61) is provided to drive a shaft (600) that is connected to the engine for igniting the engine. An axle (62) has a first end securely and centrally received in the unidirectional bearing (611) and a roller (63) is securely mounted on a second end of the axle (62). The roller (63) includes an annular groove. (631) defined in an outer periphery of the roller (63). A rope (64) is wound and received in the annular groove (631). The rope (64) has a first end secured on the roller (63) and a second end extending through the rear cover (52) after the rope (64) being wound and received in the annular groove (631). A handle (66) is connected to the second end of the rope (64) and a spring (64) is received in the roller (63) for providing a restitution force to the roller (63) after rotating.

The igniting device is operated to rotatably drive the shaft (600) for igniting the engine of a radio control model when the handle (66) is pulled. However, the engine is a heat device during operating such that the rope (64) is always in a hot condition during the engine running and gradually becoming brittle. Consequently, the brittle rope (64) is easily broken when pulled to drive the igniting device such that the radio control model cannot be used unless replacing the igniting device.

With reference to FIG. 5, it is another embodiment of the conventional igniter for an engine of a radio control model. As shown in FIG. 5, the igniter comprises a casing (74) and a coupling (71) rotatably received in the casing (74). The coupling (71) has a unidirectional bearing (711) rotatably and centrally mounted in the coupling (71). The coupling (71) is connected and drives a shaft (600) to ignite the engine of a radio control model. An axle (72) has a first end secured in the unidirectional bearing (711) and a second end extending through the casing (74). A connector (73) is securely connected to the second end of the axle (72). The connector (73) is provided to be connected to a motor (not shown) or a crank (not shown) for the user to ignite the engine by manual power or electric power. A motor or a crank is necessary to the conventional igniter. The radio control model cannot be used when the motor is broken or the crank is missing.

As described above, the utility rate of the radio control model needs to be increased and the present invention has arisen to mitigate and/or obviate the disadvantages of the two conventional igniters for an engine of a radio control model.

### SUMMARY OF THE INVENTION

The main objective of the present invention is to provide an improved igniter for an engine of a radio control model.

To achieve the objective, the igniter uses two unidirectional bearings to combine two types of igniting. The two unidirectional bearings each has a rotating direction different from each other such that the utility rate of the radio control model is increased because a broken rope and missing the crank or the motor are hardly occurred at the same time. Furthermore, the user can select a suitable igniting type in accordance with his/her habit or use condition.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an igniter for an engine of a radio control model in accordance with the present invention;

FIG. 2 is a side cross sectional view of the igniter in FIG. 1 along the line. 2-2;

FIG. 3 is an exploded perspective view of the igniter in FIG. 1;

FIG. 4 is an exploded perspective of a conventional igniter for an engine of a radio control model in accordance with the prior art; and

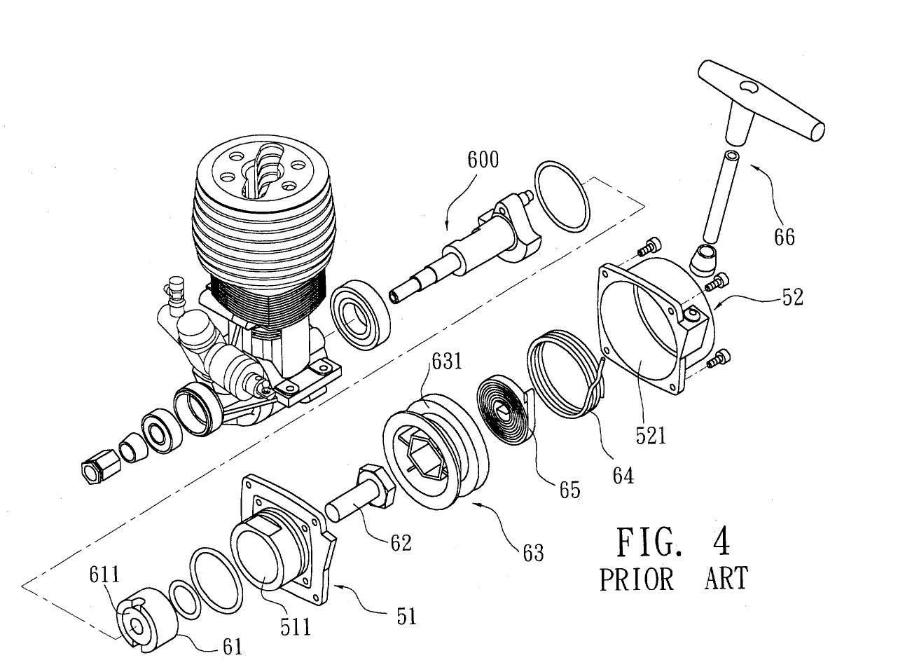

FIG. 5 is an exploded perspective view of another conventional igniter for an engine of a radio control model in accordance with the prior art.

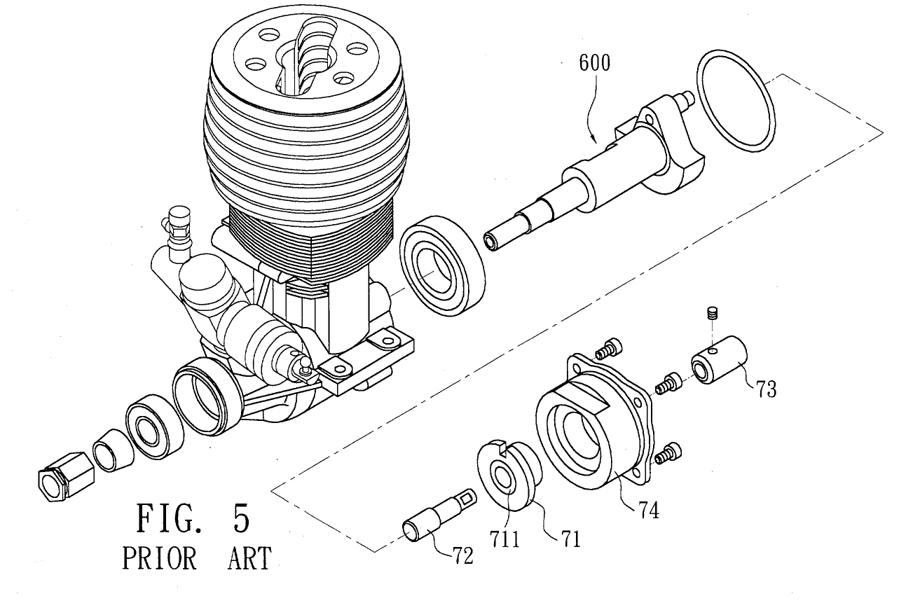

### DETAILED DESCRIPTION OF THE INVENTION

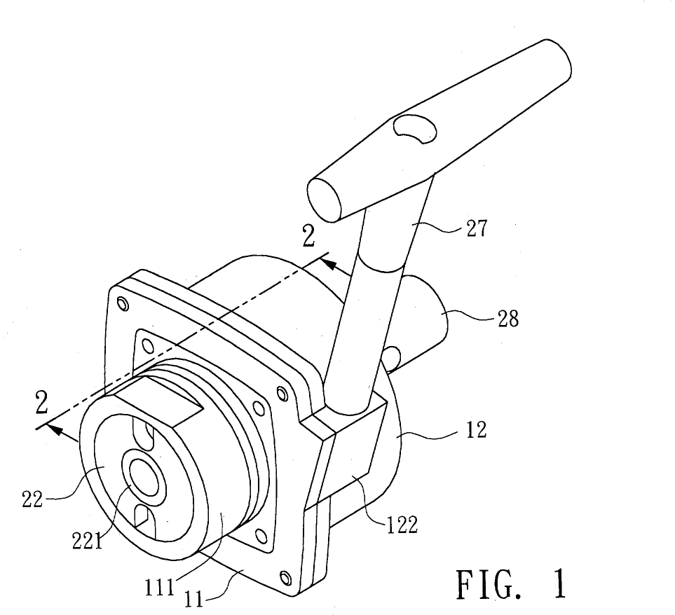

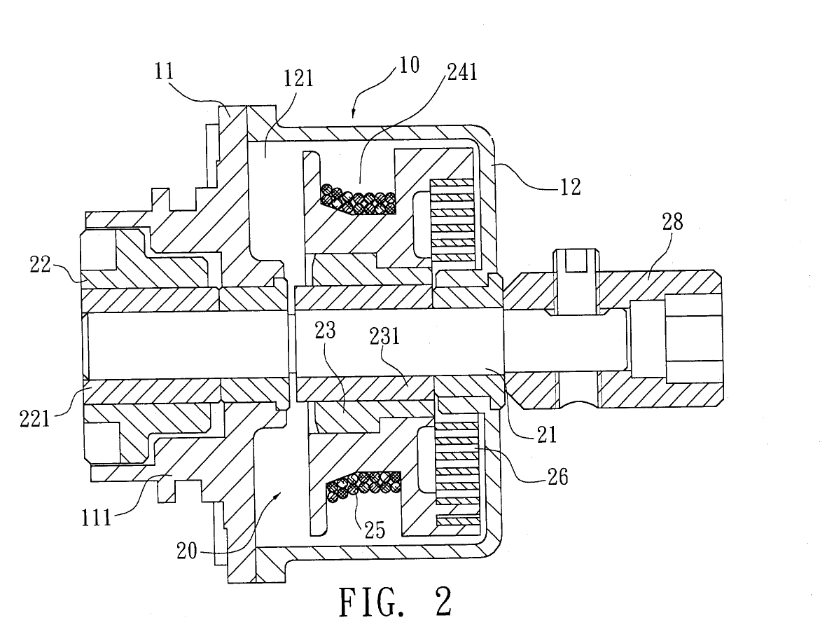

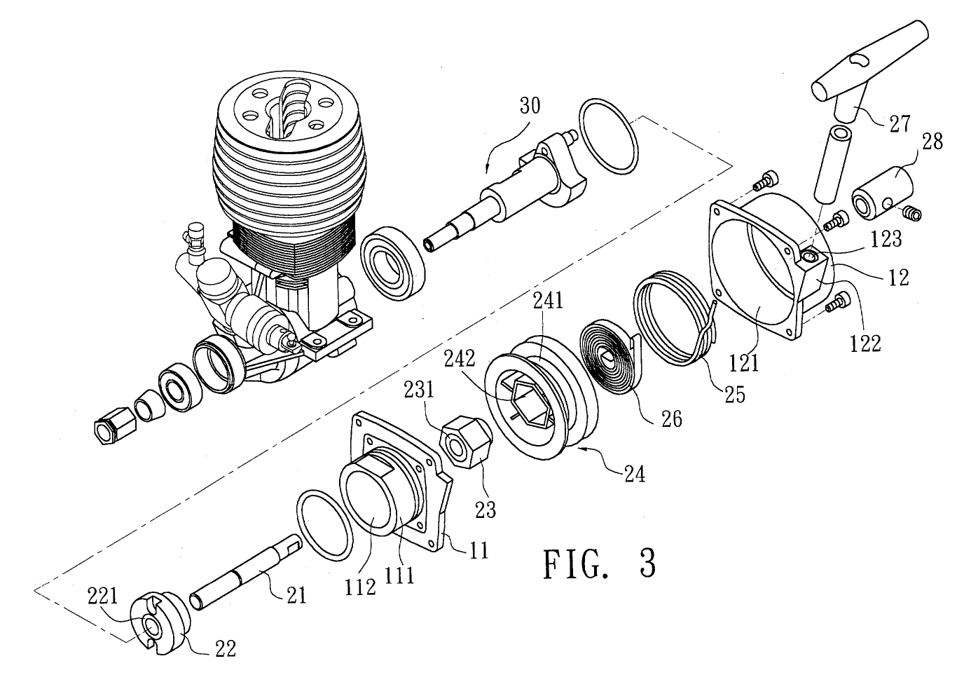

Referring to the drawings and initially to FIGS. 1-3, an igniter for an engine of a radio control model in accordance with the present invention comprises a casing (10) and an igniting device (20) received in the casing (10). The casing (10) includes a front cover (11) adapted to be secured on an outer periphery of the engine and a rear cover (12) securely abutting the front cover (11). A trough (121) is defined between the front cover (11) and the rear cover (12) for receiving the igniting device (20). In the preferred embodiment of the present invention, the rear cover (12) is cylindrical and the trough (121) is round and defined in the rear cover (12). The front cover (11) has a protrusion (111) extending therefrom and toward the engine. A passage (112) defined in the protrusion (111). The passage (112) extends through the front cover (11) and centrally communicates with the trough (121). The rear cover (12) has a block (122) formed on an outer periphery of the rear cover (12) and a through hole (123) defined in the block (122). The through hole (123) communicates with the trough (121) and is defined along a tangent line of the trough (121).

The igniting device (20) includes an axle (21) rotatably and longitudinally received in the casing (10). The axle (21) has a first end corresponding to the passage (12), a middle portion corresponding to the trough (121) and a second extending through the rear cover (12). A first coupling (22) is secures on the first end of the axle (21) and rotatably received in the passage (112). The first coupling is adapted to drive a shaft (30) that is connected to the engine for igniting the engine. The first coupling (22) has a first unidirectional bearing (221) centrally and rotatably received in the first coupling (22) and the first end of the axle (21) is securely received in the first unidirectional bearing (221). Consequently, the first unidirectional bearing (221) drives the first coupling (21) in a single direction. A connector (23) is securely sleeved on the middle portion of the axle (21). The connector (23) is polygonal and has a second unidirectional bearing (231) centrally and rotatably received in the connector (23). The middle portion of the axle (21) is securely received in the second unidirectional bearing (231). The rotating direction of the second unidirectional bearing (231) is opposite to that of the first unidirectional bearing (221) such that the second unidirectional bearing (231) is only driven by the connector (23). A roller (24) is sleeved on the connector (23) for driving the connector (32) and rotatably received in the trough (121). The roller (24) has an annular groove (241) defined in an outer periphery of the roller (24) and a polygonal hole (242) centrally defined in the roller (24) for receiving the connector (23) such that the connector (23) rotates with the roller (24). A rope (25) is wound and received in the annular groove (241) in the roller (24). The rope (25) has a first end secured on the roller (24) and a second end extending through the rear cover (21) via the through hole (123) in the block (122) after the rope (25) being wound on the roller (24). A handle (27) is connected to the second end of the rope (25) such that the roller (24) is driven when the handle (27) is pulled and the connector (23), the second unidirectional bearing (231), the axle (21), the first unidirectional bearing (221) and the first coupling (22) are further sequentially driven for driving the shaft (30) to ignite the engine. The running engine cannot drive the first coupling (22) due to the first unidirectional bearing (221).

A second coupling (28) is secured on the second end of the axle (21). The second coupling (28) is adapted to be connected to a crank (not shown) or a motor (not shown) such that the engine of the radio control model can be ignited by manual power or electric power. The roller (24) cannot be driven when the axle (21) is driven by the second coupling (28) to ignite the engine due to the second unidirectional bearing (231).

As described above, the roller (24) and the second coupling (28) are independently operated such that the utility rate of the radio control model is increased because a broken rope and missing the crank or the motor are hardly occurred at the same time. Furthermore, the user can select a suitable igniting type in accordance with his/her habit or use condition.

Although the invention has been explained in relation to its preferred embodiment, it is to be understood that many other possible modifications and variations can be made without departing from the spirit and scope of the invention as hereinafter claimed.

What is claimed is:

1. An igniter for an engine of a radio control model, comprising:
a casing adapted to be secured on an outer periphery of the engine of a radio control model, the casing including a trough defined therein and a passage defined toward the engine and communicating with the trough in the casing; and
an igniting device received in the casing and including:
an axle rotatably received in the casing, the axle having to a first end corresponding to the passage, a middle portion corresponding to the trough and a second extending through the casing;
a first coupling mounted on the first end of the axle and adapted to drive a shaft for igniting the engine, the first coupling having a first unidirectional bearing centrally and rotatably mounted in the first coupling and secured around the first end of the axle for driving the first coupling in a single direction;
a connector securely sleeved on the middle portion of the axle, the connector having a second unidirectional bearing centrally and rotatably received in the connector, the middle portion of the axle securely received in the second unidirectional bearing, the second unidirectional bearing having a rotating direction opposite to that of the first unidirectional bearing such that the unidirectional bearing only driven by the connector;
a roller sleeved on the connector for driving the connector and rotatably received in the trough, the roller having an annular groove defined in an outer periphery thereof and a hole centrally defined in the roller for securely received connector such that the connector rotates with the roller;
a rope wound and received in the annular groove in the roller, the rope having a first end secured on the roller and a second end extending through casing after the rope being wound in the annular groove of the roller;
a handle connected to the second end of the rope after the rope extending through the casing such that the roller is driven when the handle is pulled and the connector, the second unidirectional bearing, the axle, the first unidirectional bearing and the first coupling are further sequentially driven adapted for driving the shaft to ignite the engine; and
a second coupling secured on the second end of the axle and adapted to be connected to an extra power source for igniting the engine.

2. The igniter as claimed in claim 1, wherein the casing comprises:
a front cover adapted to be secured on the outer periphery of the engine and having a protrusion extending from the front cover toward the engine such that the passage of the casing is centrally defined in the protrusion of the front cover; and
a rear cover securely abutting the front cover and the trough defined in the rear cover.

3. The igniter as claimed in claim 1, wherein the trough of the casing has a round shape, and the casing has a block formed on an outer periphery of the casino and a through defined in the block, the through hole communicating with the trough and defined along a tangent line of the trough, the rope extending through the casing via the through hole in the block.

4. The igniter as claimed in claim 1, wherein the connector has a polygonal shape and the roller has a polygonal hole centrally defined in the roller for receiving the connector, the polygonal hole in the roller having a shape corresponding to that of the connector.

5. The igniter as claimed in claim 2, wherein the trough in the rear cover has a round shape, and the rear cover has a block formed on an outer periphery of the casing and a through defined in the block, the through hole communicating with the trough and defined along a tangent line of the trough, the rope extending through the casing via the through hole in the block.

6. The igniter as claimed in claim 2, wherein the connector has a polygonal shape and the roller has a polygonal hole centrally defined in the roller for receiving the connector, the polygonal hole in the roller having a shape corresponding to that of the connector.

7. The igniter as claimed in claim 3, wherein the connector has a polygonal shape and the roller has a polygonal hole centrally defined in the roller for receiving the connector, the polygonal hole in the roller having a shape corresponding to that of the connector.

8. The igniter as claimed in claim 5, wherein the connector has a polygonal shape and the roller has a polygonal hole centrally defined in the roller for receiving the connector, the polygonal hole in the roller having a shape corresponding to that of the connector.
